(19) United States
(12) Patent Application Publication
(10) Pub. No.: US 2008/0277425 A1
(43) Pub. Date: Nov. 13, 2008

(54) Container with Overhead Foam Applicator

(75) Inventors: Lutz Grasser, Stolberg (DE); Andreas Wietzke, Muenchen (DE); Volker Vanek, Duisburg (DE)

Correspondence Address: CONNOLLY BOVE LODGE & HUTZ LLP, PO BOX 2207, WILMINGTON, DE, 19899-2207, US

(73) Assignee: Henkel AG & Co. KGaA, Dusseldorf (DE)

(21) Appl. No.: 12/096,629

(22) PCT Filed: Sep. 8, 2006
(86) PCT No.: PCT/EP2006/008767

§ 371 Date: Jul. 2, 2008

(30) Foreign Application Priority Data
Dec. 14, 2005 (DE) 10 2005 060 181.2

(51) Int. Cl. B67D 5/58

(52) U.S. Cl. 222/190; 222/211

(57) ABSTRACT

A container to hold at least one flowable product has at least one air space and at least one wall that is deformable at least in some section. When the container is deformed, pressure within an air space in said container is increased. The container has at least one mixing chamber and at least one connecting element which connects the mixing chamber to the air space. When there is an increase in pressure in the air space, air and the flowable product, which has a viscosity of less than 250 mPa*s at room temperature, and includes a proportion of foaming agents of greater than 10% by weight, can be brought together in the mixing chamber in an essentially turbulent manner.

### CROSS REFERENCE TO RELATED APPLICATIONS

This application is a national stage application (under 35 U.S.C. 371) of PCT/EP20061008767 filed Sep. 8, 2006, which claims benefit of German application 10 2005 060 818.2 filed Dec. 14, 2005.

The invention relates to a container with an overhead foam applicator.

### BACKGROUND OF THE INVENTION

Consumer products such as for instance personal hygiene or cleaning agents are conventionally offered for sale as substances and/or preparations in liquid, gel or particulate form. These flowable or pourable products are conventionally discharged from the corresponding packages or containers without undergoing any change in their original state, a shampoo, for example, is conventionally discharged from a shampoo bottle as a flowable, gel-like product.

A trend is, however, to be observed that customers find it attractive for it to be possible to discharge personal hygiene or cleaning agents from the corresponding product package in the form of a foam.

“Foam” pumps are, for example, used to produce foam. These generally consist of two reciprocating pumps which are arranged in and coupled with one another and, on the one hand, deliver a liquid product and simultaneously compress air, the two streams of fluid being brought together to produce the foam in a mixing chamber. A dispensing head is conventionally arranged on the reciprocating piston rod of the pumps, it being necessary to move the dispensing head against a spring force acting on the reciprocating piston rod in order to produce foam.

Although good foam qualities can be achieved with these foam pumps, considerable structural complexity is involved, especially as a result of the moving parts of the reciprocating pumps and the necessary valve arrangements. As a result, manufacturing costs have hitherto been high for this kind of foam pump, so making the production of a high-quality foam economically unattractive for many applications.

This kind of foam pump is furthermore subject to a certain degree of wear due to friction of the reciprocating pistons against the cylinder walls of the pumps, meaning that the quality of the foam produced by these foam pumps declines continuously over the course of service.

Another disadvantage of known foam pumps is that they cannot be operated with one hand in many applications. Foam pumps are conventionally used on freestanding containers, which means that the pump can only be operated if the corresponding container is standing securely on a solid base. If such a surface is not available to accommodate the container, for example in a shower, then foam production requires one hand to hold the container and another one to actuate the pump. This is clearly wholly impractical for many applications.

It is also disadvantageous that, in the described foam pumps, the pump stroke determines the release of a defined volume of foam. It is thus not possible to release a variable volume under the user's control.

In addition to foam pumps, foam applicators are also known in the prior art, in which the product to be foamed is brought together with a stream of compressed air, the pressure necessary for this purpose being produced not by a pump but instead by compressing or squeezing a resilient wall of the container.

U.S. Pat. No. 3,937,364, entitled “Foam Dispensing Device”, for example discloses a container with resilient walls, pressure being exerted on the air located in the container by pressing the walls together. This increase in pressure results in the air located in the container and the liquid located in the container being conveyed into a porous element in which the foam to be applied is then produced. The disadvantage of this solution is that the container cannot be kept with the applicator facing downwards without leaking, since in this case the porous element is exposed to a continuous pressure from the fluid column located above it, which inevitably results in the porous element being loaded with product until its capacity is exhausted and product runs out from the porous element.

Another disadvantage of the solution known from U.S. Pat. No. 3,937,364 is the comparatively large pore size of the foam produced, making it look inconsistent and not stiff. This is largely determined by the fact that, when the bottle is compressed with a variable level of force, variable pressure and flow conditions prevail for foam generation in the porous element, so resulting in highly variable foaming results.

U.S. Pat. No. 4,044,923, entitled “Foam Generating Dispenser”, discloses a foam dispenser for a squeezable container, in which a further, but movable porous element is arranged downstream from a first, fixed porous element in order to produce foam in a conically tapering jet. The movable porous element substantially has the function of breaking up the foam produced by the first porous element. The intention is to produce a foam with a reduced bubble size, as a result of which the foam is stiffer and more homogeneous. This solution also has the problem that it cannot prevent the product from being released to the surroundings once the porous elements are saturated.

U.S. Pat. No. 4,274,594, entitled “Foam Generating and Dispensing Device”, claims a foam dispenser for a squeezable container consisting of a closing cap which, together with the container, defines a mixing chamber which comprises two porous elements. The closing cap comprises a jet orifice, from which the foam formed in the mixing chamber can be discharged into the surroundings. The closing cap may assume a closed position on the container in which it closes the mixing chamber relative to the surroundings as well as an open position in which it causes the mixing chamber to communicate with the surroundings via the jet orifice. In this way, leaks from the closure can be prevented even when the container is stored upside down.

The substantial disadvantage of all the described overhead squeeze foamers in comparison with known pump foamers is that, when the bottle is compressed with a variable level of force, variable pressure and flow conditions for foam generation prevail in the mixing chamber or in a porous element, whereby highly variable foaming results are achieved. This disadvantage cannot be overcome by any of the solutions previously described in the prior art.

Furthermore, the problem subsists for all foam applicators of the stated kind that product to be foamed may get into the mixing chamber or a porous element before the incoming air is flowing in with sufficient pressure for foaming. The same problem arises at the end of a foaming cycle when the user reduces the pressure on the bottle by releasing the squeezing movement and air can no longer flow into the mixing chamber with sufficient pressure for foaming.

The quality of the foam produced is distinctly reduced as a result, particularly at the beginning and towards the end of the foaming process.

It is therefore an object of the present invention to provide an overhead foam applicator operable with a single hand, which may be manufactured substantially without moving parts in a structurally simple and thus inexpensive manner and, with the product to be foamed, ensures the generation and application of a high-quality, fine-pored and stiff foam substantially irrespective of how the user squeezes. The invention has the advantage over solutions known from the prior art that foam of a permanently constant quality can be produced.

### BRIEF DESCRIPTION OF THE DRAWINGS

The invention is explained using exemplary embodiments with reference to drawings, in which:

FIG. 1 shows a container with foam applicator in cross-section.

FIG. 2 shows a twin chamber container with a one-part foam applicator in cross-section.

FIG. 3 shows a cross-sectional view of a twin chamber container with a one-part foam applicator which has separate mixing chambers.

FIG. 4 shows a twin chamber container with separate foam applicators in cross-section.

FIG. 5 shows a twin chamber container with chambers arranged inside one another and a one-part foam applicator with an air feed element.

FIG. 6 shows a twin chamber container with chambers arranged inside one another and a common foam applicator with separate air feed elements.

FIG. 7 shows a twin chamber container with chambers arranged inside one another and a common foam applicator with separate air feed elements for freestanding application.

FIG. 8 shows a twin chamber container with chambers arranged inside one another and series-connected foam applicators with separate air feed elements.

FIG. 9 shows a twin chamber container with chambers arranged inside one another and series-connected foam applicators with a common air feed element.

FIG. 10 shows a container with “bag-in-bottle” arrangement and foam applicator.

FIG. 11 shows a container with closing mechanism in closed position.

FIG. 12 shows a container with closing mechanism in open position.

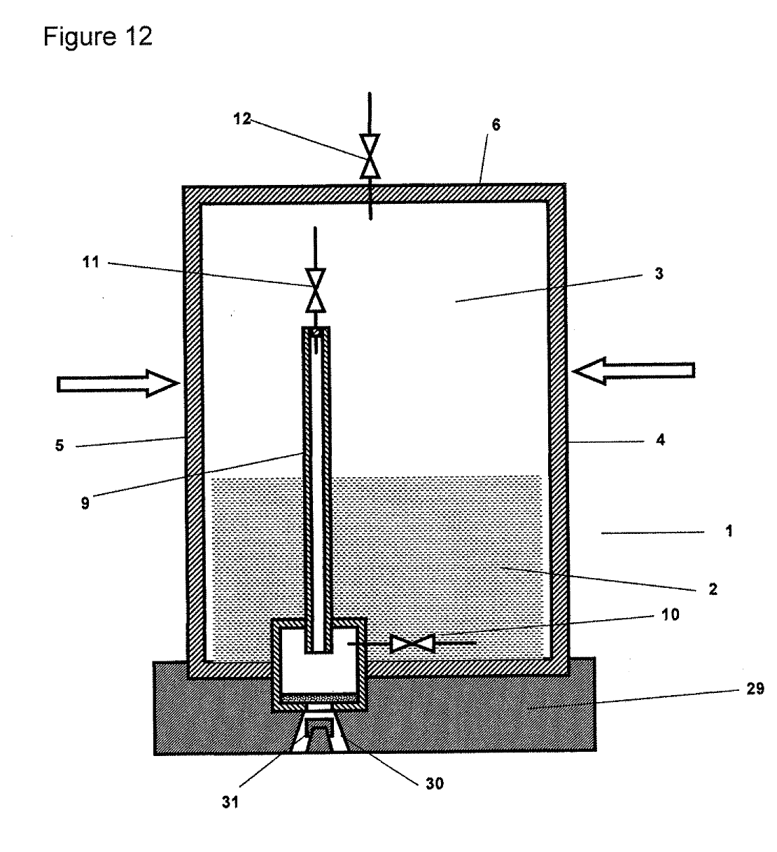

FIG. 13 shows a multi-chamber container with two product chambers and an air chamber with a common foam applicator with separate mixing chambers and a rotary device.

### DETAILED DESCRIPTION

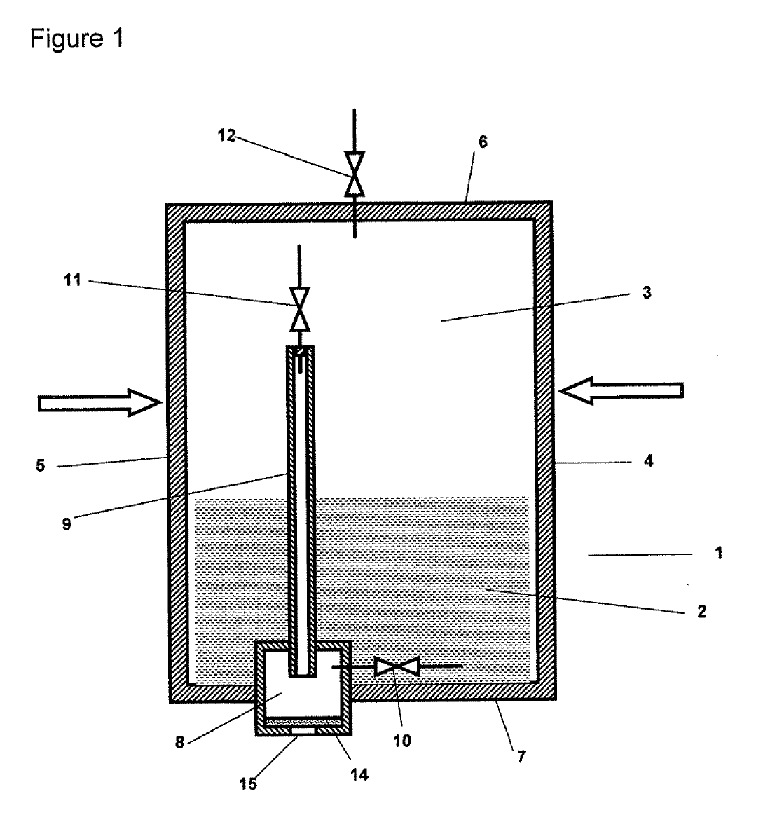

FIG. 1 shows a container (1) according to the invention with a foam applicator (8, 9, 10, 11, 14, 15) in cross-section. The container (1) has outer container walls (4, 5) and an upper container wall (6) and a bottom container wall (7). The bottom container wall (7) has an orifice for accommodating the foam applicator (8, 9, 10, 11, 14, 15) or for releasing the foam produced by the foam applicator (8, 9, 10, 11, 14, 15).

At least one container wall (4, 5, 6, 7) is designed such that applying a force substantially directed towards the interior of the container (1) onto one of the container walls (4, 5, 6, 7) brings about an increase in pressure in the airspace (3) of the container (1).

According to a preferred embodiment of the invention, this increase in pressure is brought about by a change in volume, with the force which brings about the pressure change acting on at least one of the deformably designed container walls (4, 5, 6, 7). One of the external container walls (4, 5) is preferably of deformable design, and particularly preferably both the outer container wall (4) and the outer container wall (5) are of deformable design.

The container walls (4, 5, 6, 7) should preferably be of resilient construction. This means that the deformable walls (4, 5, 6, 7) are designed such that, after deformation, they substantially automatically return to the original shape of the walls (4, 5, 6, 7) prior to deformation. In order to bring this about, the container walls (4, 5, 6, 7) may at least by sections be formed from resilient materials.

The container (1) is filled with a flowable product (2) in such a manner that, above the liquid level and substantially defined by the lateral container walls (4, 5) and the upper container wall (6), an airspace (3) is formed.

The foam applicator (8, 9, 10, 11, 14, 15) substantially consists of a mixing chamber (8) which is connected via a communication element (9), on which an air feed element (11) is arranged, with the airspace (3), a product feed element (10), which connects the mixing chamber (8) with the product (2) filled space of the container (1) and a dispensing orifice (15) which creates a connection between the dispensing chamber (8) and the surroundings.

The mixing chamber may additionally comprise a porous element (14). A porous element for the purposes of the present application comprises all two- or three-dimensional structures which are suitable for conveying a product (2) through the structure and, in so doing, foaming it or breaking up a foam in order to impart a more uniform structure thereto. In particular, the porous element (14) may take the form of a mesh, screen or open-pored foam. The porous element (14) may also be constructed from any desired combinations of a plurality of these structures, preferably arranged in layers.

According to a preferred embodiment of the invention, the entire mixing chamber (8) is filled with one or more porous elements (14). In particular, the porous element (14) may also be passed through by channels which convey air and/or product.

The mixing chamber (8) moreover comprises a communication element (9) which connects the mixing chamber (8) with the airspace (3). The communication element (9) may preferably take the form of a tube or hose which may be attached in leakproof manner via a suitable connection to the mixing chamber (8).

The end of the communication element (9) projecting into the airspace (3) comprises an air feed element (11). This air feed element (11) is suitable for regulating the flow of air through the communication element (9) into the mixing chamber (8). In a preferred embodiment, the air feed element (11) takes the form of a valve.

In an alternative embodiment of the invention the air feed element (11) may also be arranged in any desired position within the communication element (9). It is also possible to incorporate the air feed element (11) into the communication element (9) or the mixing chamber (8).

According to a particularly preferred embodiment, the air feed element (11) is designed such that it effects the inlet of air from the airspace (3) into the mixing chamber (8) only once a defined pressure in the airspace (3) has been exceeded. The air feed element (11) should moreover preferably be constructed such that it prevents the inlet of air from the airspace (3) into the mixing chamber (8) when the pressure in the airspace (3) falls below a defined level.

The mixing chamber (8) is moreover connected via a product feed element (10) with the space of the container (1) which is filled with product (2). The product feed element (10) is suitable for regulating flow of product into the mixing chamber (8). In a preferred embodiment, the product feed element (10) takes the form of a valve.

The mixing chamber (8) is constructed such that mixing of air and product (2) is brought about, preferably under turbulent conditions. In a particularly preferred embodiment, the container and the foam applicator (8, 9, 10, 11, 14, 15) are configured such that mixing of air and product (2) in the mixing chamber proceeds at Reynolds numbers of greater than 1,000.

It may, for example, be provided to this end that the air feed element (11) and the product feed element (10) are configured such that air and product (2) can only flow into the mixing chamber (8) once a defined pressure in the airspace (3) has been exceeded.

In addition, the inlets for the air and/or the product (2) may take the form of jets in order, by increasing the velocity of the particular fluid, to increase the degree of turbulence during mixing of the air and product (2). The inlets may also be constructed such that swirl is additionally imparted to the fluid.

The mixing chamber (8) may furthermore comprise devices which contribute towards increasing the turbulence in the mixing chamber (8). These may be, for example, appropriately arranged baffles or flow guides.

According to a particularly preferred embodiment of the invention, the air feed element (11) is constructed such that, in the event of an increase in pressure in the airspace (3), it permits the inlet of air from the airspace (3) into the mixing chamber (8) before the product feed element (10) permits the inlet of product (2) into the mixing chamber (8). The product feed element (10) should particularly advantageously be constructed such that, in the event of a pressure drop in the airspace (3), it stops the inlet of product (2) into the mixing chamber (8) before the air feed element (11) shuts off the inlet of air from the airspace (3) into the mixing chamber (8). Thanks to this advantageous configuration of air feed element (11) and product feed element (10), it is possible to avoid product (2) entering the mixing chamber (8) before a stream of air sufficient for foaming can be passed into the mixing chamber (8).

In a further development of the invention, the air feed element (11) and product feed element (10) are configured such that the inflow of air or product into the mixing chamber (8) is pulsed.

The container furthermore comprises a pressure equalising valve (12) which is designed such that, when a reduced pressure prevails in the airspace (3), air can flow in from the surroundings into the airspace (3).

According to another possible embodiment of the invention, the pressure equalising valve (12) may be arranged on the upper container wall (6).

The pressure equalising valve (12) may, for example, also take the form of an appropriately designed connection between the foam applicator (8, 9, 10, 11, 14, 15) and the container (1). It is particularly advantageous to construct this connection as a screw-in or snap-in connection.

The product feed element (10) and/or air feed element (11) and/or pressure equalising valve may, according to a preferred embodiment thereof in each case be selected individually or as a combination from the group of straight-way valves, system medium-actuated valves, foreign medium-actuated valves, nonreturn valves, spring-loaded valves, weight-loaded valves, disk valves, slanted seat valves, rolling-membrane valves, pinch valves, throttle valves, nonreturn throttle valves, shuttle valves, two-pressure valves, delay valves, pressure-limiting valves, sequence valves, closed-loop pressure control valves, differential pressure valves, pressure relief valves, control valves, inlet valves, outlet valves, shut-off valves, closed-loop and/or open-loop control valves.

The foam applicator may also comprise means which ensure that inflow of air into the mixing chamber (8) may be allowed or prevented as required by a user. This makes it possible to discharge a product (2) disposed in the container (1) from the container (1) alternatively in foamed form or in its original state, for example as a gel.

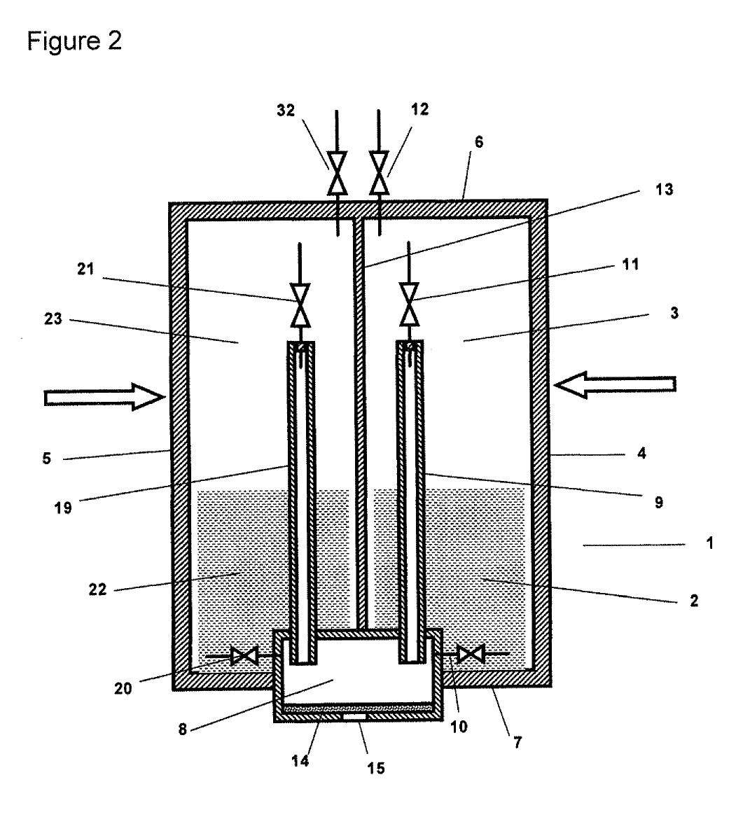

FIG. 2 shows a cross-sectional view of the container (1) according to the invention in a twin chamber embodiment.

The container (1) comprises two chambers (2, 3, 22, 23) which are separated from one another by a partition (13). It is, of course, also possible to join together two individual containers to form a twin chamber arrangement of the above-described kind. Furthermore, more than two chambers filled with a product may also be present.

Each of the chambers contains one product (2, 22). It is particularly advantageous to arrange two products (2, 22) which are different from one another in the chambers. The products (2, 22) may, for example, differ with regard to their colorant or fragrance composition or may alternatively comprise substances or mixtures of substances which, once mixed together, are not stable in storage. It may furthermore be advantageous for the products (2, 22) to contain substances which release gas on mixing so as to improve foaming.

In each of the chambers, there is located above the liquid level (2, 22) a airspace (3, 23), these being formed respectively by the liquid level of the product (2), the outer container wall (4), the upper container wall (6) and the partition (13) and by the liquid level of the product (22), the outer container wall (4), the upper container wall (6) and the partition (13).

The mixing chamber (8) is connected via the communication element (9) with the airspace (3) of the first chamber and via the communication element (19) with the airspace (23) of the second chamber. The mixing chamber (8) comprises two product inflow elements (10, 20) which respectively connect the mixing chamber (8) with the product (2) disposed in the first chamber and with the product (22) disposed in the second chamber.

The communication elements (9, 19) in each case comprise an air feed element (11, 21) which controls the feed of air from the airspace (3, 23) into the mixing chamber (8).

According to a particularly preferred embodiment of the invention, the air feed elements (11, 21) are constructed such that, in the event of an increase in pressure in the airspace (3), they permit the inlet of air from the airspaces (3) and (23) into the mixing chamber (8) before the product feed elements (10) and (20) permit the inlet of product (2) and/or (22) into the mixing chamber (8). It is moreover particularly advantageous to construct the product feed elements (10, 20) such that, in the event of a pressure drop in the airspace (3) or (23), they stop the inlet of product (2) into the mixing chamber (8) before the air feed elements (11) and (21) shut off the inlet of air from the airspace (3) into the mixing chamber (8).

Thanks to this advantageous configuration, it is possible to avoid product (2, 22) entering the mixing chamber (8) before a stream of air sufficient for foaming can be passed into the mixing chamber (8).

Depending on the composition of the products (2, 22), it may likewise be advantageous for the air feed elements (11) and (21) and the product feed elements (10) and (20) to be configured such that the product (2) or (22) is foamed in the common mixing chamber (8) with a time delay. In this manner it in particular possible to tailor the individual time delayed phases of the foaming processes optimally to the particular products (2) and (22) to be foamed.

The individual chambers of the container (1) (FIG. 2) in each case comprise pressure equalising valves (12, 32) which are designed such that, when a reduced pressure prevails in the particular airspace (3) and/or (23), air can flow in from the surroundings into the corresponding airspace (3) or (23). In one particular embodiment of the invention, it may be provided that only one chamber is equipped with a pressure equalising valve (12) or (32) and that a further pressure equalising valve is arranged in the partition (13).

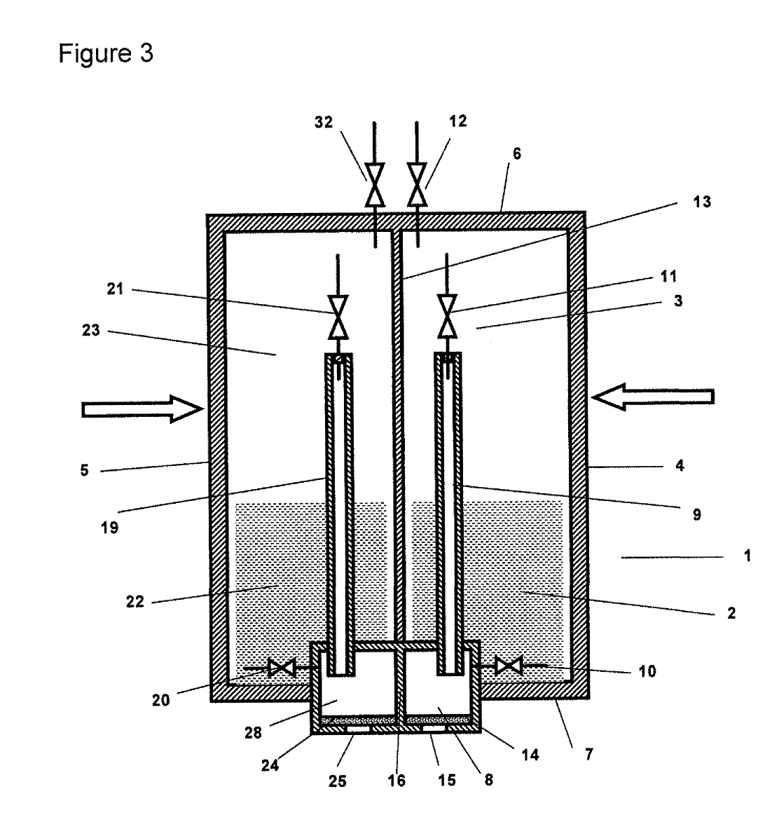

FIG. 3 shows a cross-sectional view of the twin chamber container (1) known from FIG. 2 with a one-part foam applicator, which according to a further embodiment comprises the separate mixing chambers described below.

In contrast to the mixing chamber of FIG. 2, the mixing chamber in FIG. 3 comprises a partition (16) by which are formed two separate mixing chambers (8) and (28) which are divided from one another. This makes it possible for a product (2) or (22) from one of the chambers of the container to be foamed in isolated manner in each case spatially separately in its own mixing chamber (8) or (28). The mixing chambers (8) and (28) may be shaped specifically in accordance with the foaming properties of products (2) and (22), in order in each case to establish optimum foaming conditions in the corresponding mixing chamber (8) or (28).

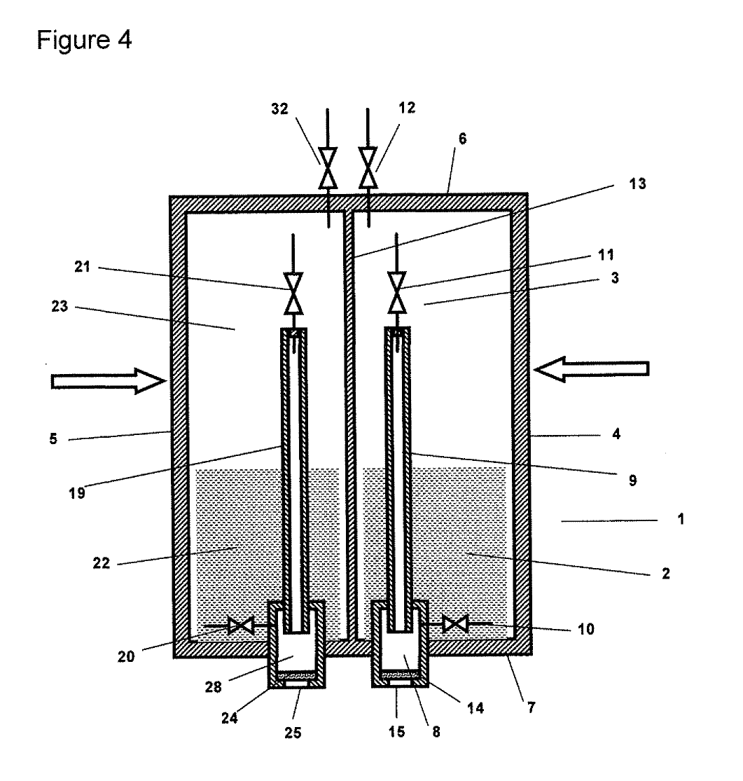

FIG. 4 shows a twin chamber container (1) according to the invention with in each case separate foam applicators divided spatially from one another. According to this exemplary embodiment, each of the chambers in each case comprises a separate foam applicator. To reduce manufacturing costs, it is particularly advantageous for the foam applicators for each chamber to be in each case of identical construction.

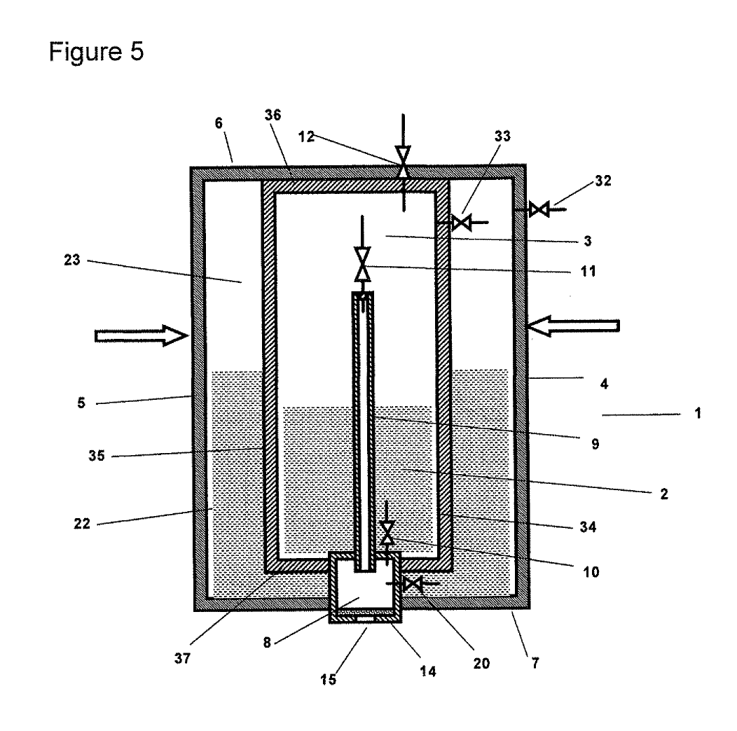

FIG. 5 shows, in one particular embodiment, a twin chamber container with chambers arranged inside one another and a common foam applicator with an air feed element. According to this embodiment, the container (1) has an outer container consisting of the outer container walls (4) and (5), the outer upper container wall (6) and the bottom container wall (7). Inside the container space formed in this way there is arranged a second chamber, which is formed from the inner side walls (34) and (35) and the upper side wall (36) and the bottom side wall (37).

At least one container wall (4, 5, 6, 7) is designed such that applying a force substantially directed towards the interior of the container (1) onto one of the container walls (4, 5, 6, 7) brings about an increase in pressure in the airspace (23) of the container (1).

The mixing chamber (8) comprises a product feed element (10), which passes the product (2) out of the inner container into the mixing chamber (8). A second product feed element (20) is additionally arranged on the mixing chamber (8) for passing the product (22) from the outer chamber into the mixing chamber (8).

The mixing chamber (8) comprises a communication element (9), which connects the mixing chamber with the airspace (3) of the inner chamber. Alternatively, it is also possible for a communication element (9) to connect the mixing chamber (8) with the airspace (23) of the outer chamber. The container (1) comprises a pressure equalising valve (12), which enables pressure equalisation between the surroundings and the airspace (3) of the inner container chamber. The container (1) comprises a second pressure equalising valve (33) or (32), which brings about pressure equalisation either between the inner and outer chambers or the outer chamber and the surroundings.

The walls (34), (35), (36) and (37) of the inner chamber are so designed that applying a force to the walls which is directed towards the inside of this chamber brings about an increase in pressure in the airspace (3).

According to a particularly preferred embodiment of the invention, the product inflow elements (10) and (20) may be designed such that the products (2) or (22) are passed in a specific, defined mixing ratio into the mixing chamber (8). It may also be advantageous to configure the product inflow elements (20) and (10) such that the particular product (2) or (22) is passed at different times and/or in pulsed manner into the mixing chamber.

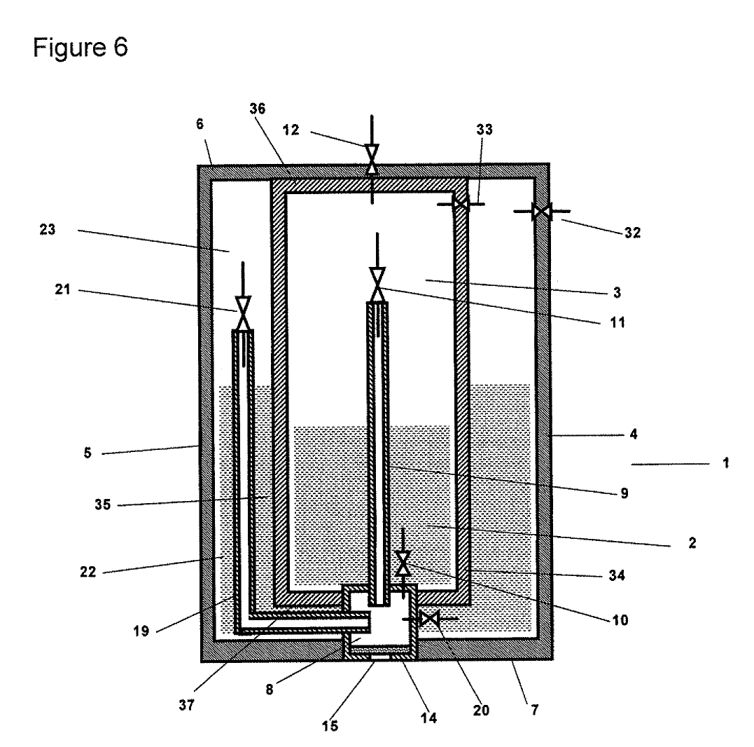

FIG. 6 shows a further development of the container according to the invention in which, compared with the container shown in FIG. 5, a further communication element (19) connects the mixing chamber (8) with the airspace (23) of the outer container. The communication element (19) has an air feed element (21). An accordingly suitable configuration of the air feed elements (11) and (21) and the product feed elements (20) and (10) makes it possible precisely to control product feed ratios and times and air feed conditions.

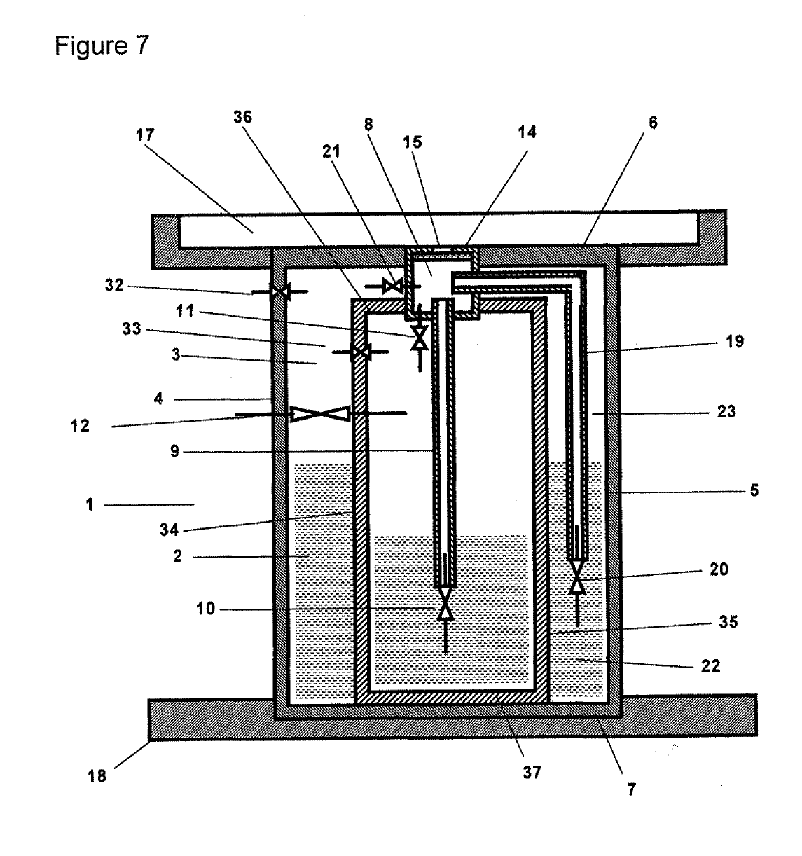

FIG. 7 shows the container known from FIG. 6 turned through 180°. In addition, in this position the container (1) comprises a plate element (17) and a container foot (18). The side walls (4) and (5) of the container (1) are designed such that a force directed towards the inside of the container effects an increase in pressure in the airspace (3) or (23) which is sufficient to convey product (2) or (22) respectively out of the inner or outer chamber respectively through the communication elements (9) or (19) respectively into the mixing chamber (8). The walls (4) and (5) may be of folding bellows-type construction, in order to bring about a reduction in volume of the container (1) when force directed parallel to the walls (4) and (5) is applied to the upper or bottom container wall (6) or (7). In this case, the inner container walls (34), (35) also advantageously have a folding bellows-type structure.

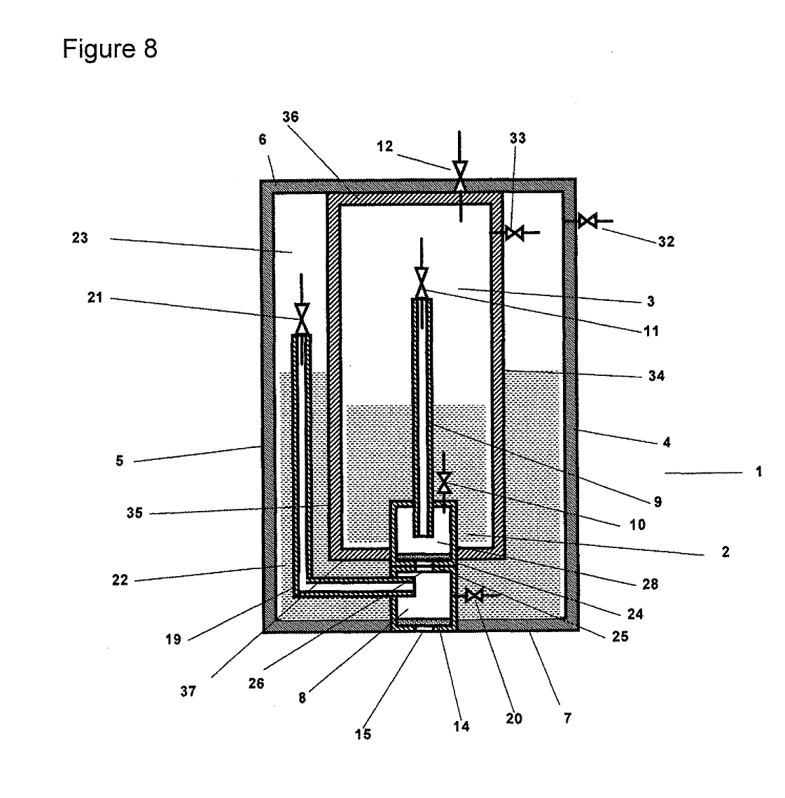

FIG. 8 shows a twin chamber container according to the invention with chambers arranged inside one another and series-connected foam applicators with separate air feed elements. Here, the container (1) comprises a first inner chamber, which is formed by the side walls (34) and (35) and the inner upper container wall (36) and the inner bottom container wall (37). A first product (2) is disposed in this chamber. Above the liquid level of the product (2) there is located a first airspace (3). The inner bottom container wall (37) comprises an orifice, into which the foam applicator is set in leakproof manner. Below this first foam applicator there is arranged a second foam applicator, which is connected with the first foam applicator and which passes product (2) out of the outer chamber of the container (1) via a product feed element (20) into the mixing chamber (8) and air out of the airspace (23) via a communication element (19) into the mixing chamber. The mixing chamber (28) is connected with the mixing chamber (8) via the dispensing orifice (25) and the communication orifice (26).

The series connection of the mixing chambers (28) and (8) makes it possible, with a foam produced initially in the mixing chamber (28), to adjust certain physical or chemical properties of the foam in the mixing chamber (8) by a suitable supply of air and product (20).

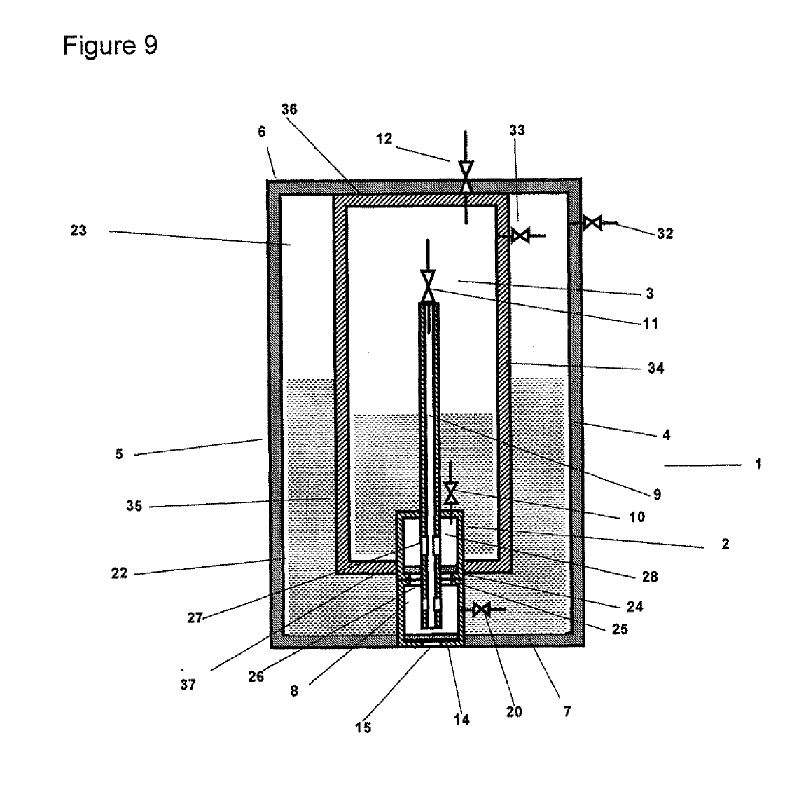

FIG. 9 shows a further possible embodiment of the container known from FIG. 8, wherein air is fed into both mixing chambers (8) and (28) by a single communication element (9). As an alternative to the exemplary embodiment shown in FIG. 9, it is also possible for the communication element (9) to connect the two mixing chambers (8) and (28) with the airspace (23) of the outer chamber of the container (1).

The communication element (9) comprises air inlet orifices (27), which allow outlet of air from the communication element (9) into the mixing chambers (8) and (28).

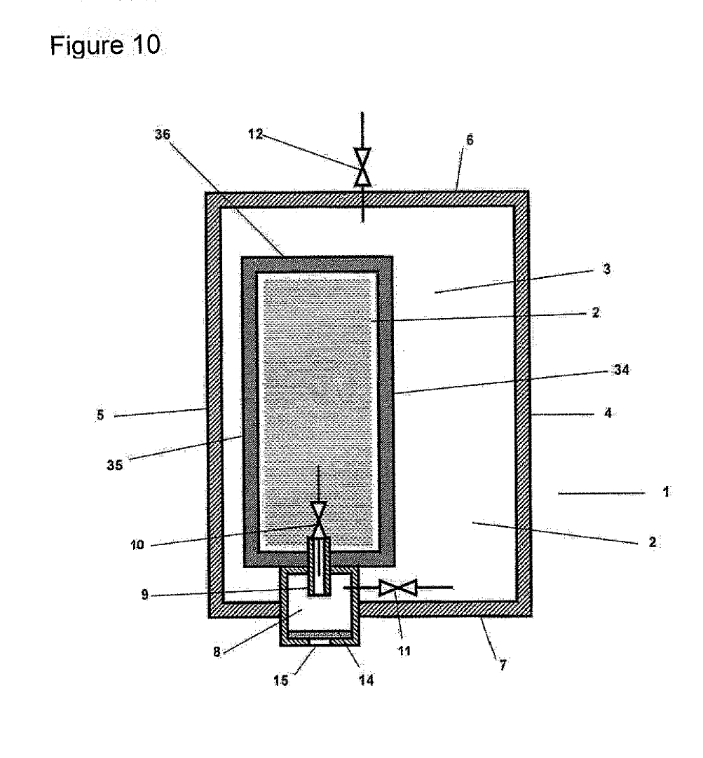

FIG. 10 shows the container of FIG. 5 in a particular embodiment in which the inner chamber is formed substantially from a flexible pouch and together with the container constitutes a “bag-in-bottle” configuration. The pouch is preferably completely filled with a product (2), which may be conveyed via a communication element (9) and a product feed (10) into the mixing chamber (8). This is brought about substantially by an increase in pressure inside the airspace (3) of the container (1), which is produced according to the invention by deformation of the outer side walls (5) or (4). The outer chamber forms a product-free airspace (3). The mixing chamber (8) is connected with this airspace (3) via an air feed element (11). According to a particularly advantageous embodiment of the invention, the pouch does not have a pressure equalising valve.

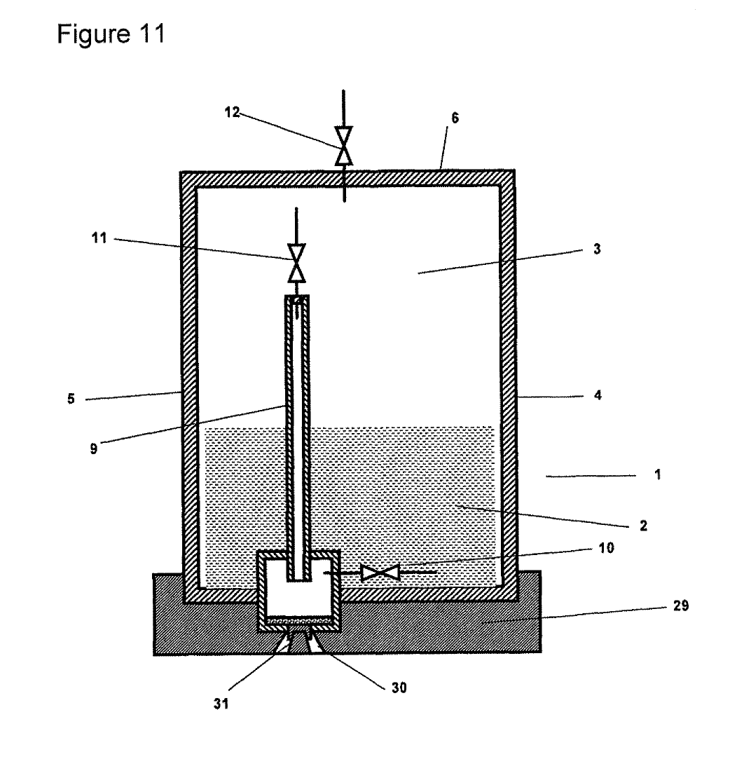

FIG. 11 shows a closing mechanism for the foam applicator according to the invention. The closing mechanism comprises an applicator foot (29), a foam outlet orifice (30) and a closing element (31). The foam outlet orifice is preferably funnel-shaped. The applicator foot (29) is arranged on the container (1) or on the foam applicator in such a way as to be displaceable substantially parallel to the side walls (4) and (5), such that a “push-pull” closure is formed. This is preferably configured such that, if the opened container (1) is set down on the closure, the closing mechanism closes the orifice (15) of the foam applicator under a defined set-down force, such as for example the container's (1) own weight. It is particularly advantageous for the closing mechanism to lock into place audibly.

Alternatively, provision may also be made for the orifice (15) of the foam applicator to be closable by a rotary or snap-in closure.

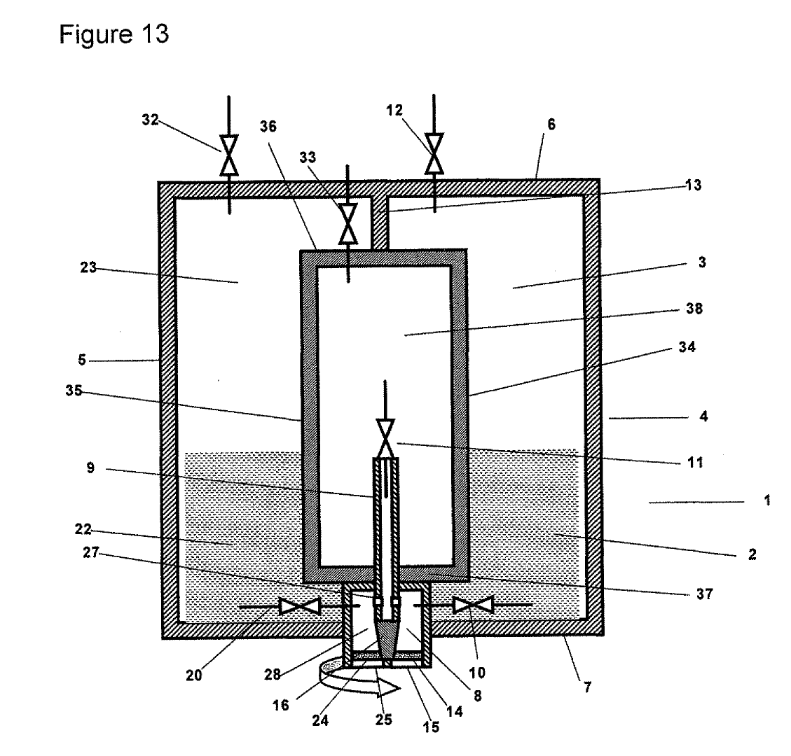

FIG. 13 shows another embodiment of the invention, which consists of two product chambers and a separate air chamber. The mixing chamber (8) or (28) is here connected with the airspace (38) via the communication element (9). The mixing chamber comprises two zones (8) and (28) divided from one another, into which product (2) or (22) respectively may in each case be fed via the product feed elements (10) or (20) respectively. The communication element (9) comprises air inlet orifices (27), which allow inflow of air into the two zones (8) and (28) of the mixing chamber.

According to a preferred embodiment of the invention, the foam applicator is arranged rotatably on the container (1). Alternatively, it is also possible to mount the dispensing orifices (15) and (25) rotatably in the foam applicator (8). It is thus possible, in conjunction with differently coloured products (2) and (22), to produce a foam with a swirling or spiral coloured pattern. The rotational movement of the foam applicator or of the dispensing orifices necessary therefor may be achieved by suitable means, which may convert pressure or flow of air or product (22) or (2) into a rotational movement.

A further advantageous development of the invention provides for the airspace (38) to be under a higher pressure than the surroundings. Thus, for example, the container enclosing the airspace (38) may take the form of a pressure cartridge. In this case, the air feed element (11) is designed such that an increase in pressure in the airspace (23) or (3) passes air out of the pressurised airspace (38) through the communication element (9) into the mixing chamber (8).

The container according to the invention is suitable in particular for foamable, flowable cosmetic products such as for example shampoo, liquid soap or shower gel or foamable, flowable cleaning products such as dishwashing detergent, glass cleaners, universal cleaners, etc.

The flowable product, which is foamable for the purposes of the present application, comprises at least one surfactant, which functions as a foaming agent, and one solvent, wherein the term solvent may include water. It is particularly advantageous to use a surfactant mixture consisting of anionic and amphoionic surfactants. In the formulations of the product to be foamed, a foaming agent may preferably be used which is suitable for rapid foaming (quick surfactant). The formulation preferably contains no foam-destroying or foam-impeding agents (for example alcohol).

It has been found that, to produce a stable foam, there is a need not only for adequate turbulence in the mixing chamber but also for a sufficiently high concentration of foaming agents or surfactants and satisfactory fluidity of the products to be foamed.

Preferably, the concentration of foaming agents in a product foamable with the container according to the invention is over 10 wt. %. To ensure sufficient fluidity, the viscosity of the product to be foamed should preferably be less than 250 mPa·s.

Some example formulations of a foamable, flowable product are described below.

Substances which also serve as ingredients in cosmetics are, where applicable, named in accordance with the International Nomenclature of Cosmetic Ingredients (INCI). Chemical compounds have an INCI name in English, plant ingredients are only listed in Latin using the Linnaean classification. “Common” names such as “water”, “honey” or “sea salt” are likewise stated in Latin. INCI names may be found in the “International Cosmetic Ingredient Dictionary and Handbook, Seventh Edition (1997)” which is published by The Cosmetic, Toiletry and Fragrance Association (CTFA), 1101, 17th Street NR, Suite 300, Washington, D.C. 20036, USA, and contains more than 9,000 INCI names and references to more than 37,000 trade names and technical terms including the associated distributors from more than 31 countries. The International Cosmetic Ingredient Dictionary and Handbook assigns the ingredients one or more chemical classes, for example “polymeric ethers”, and one or more functions, for example “Surfactants—Cleansing Agents”, which it in turn explains in greater detail. Where applicable, reference is made thereto below.

The abbreviation CAS means that the following sequence of numbers is a Chemical Abstracts Service number.

Unless explicitly stated otherwise, the quantities stated in weight percent (wt. %) relate to the entire agent.

### Example of a Foamable Dishwashing Detergent

The agent according to the invention contains surfactants in a total quantity of conventionally 8 to 60 wt. %, preferably 10 to 45 wt. %, in particular 20 to 40 wt. %.

Anionic surfactants are primarily present, but nonionic and/or amphoteric surfactants may also be present. In a preferred embodiment, the agent may accordingly for example contain a surfactant combination of alkyl ether sulfate, secondary alkyl sulfonate and betaine, while in further preferred forms alkylpolyglycosides may, for example, be present.

The anionic surfactants are conventionally used as an alkali metal, alkaline earth metal and/or mono-, di- or trialkanolammonium salt and/or alternatively also in the form of the corresponding acid thereof to be neutralised in situ with the corresponding alkali metal hydroxide, alkaline earth metal hydroxide and/or mono-, di- or trialkanolamine. Preferred alkali metals are here potassium and in particular sodium, while preferred alkaline earth metals are calcium and in particular magnesium, and preferred alkanolamines are mono-, di- or triethanolamine. Sodium salts are particularly preferred.

### Anionic Surfactants

Suitable anionic surfactants are primarily alkyl ether sulfates and secondary alkane sulfonates. Aliphatic sulfates such as fatty alcohol sulfates, monoglyceride sulfates and ester sulfonates (sulfofatty acid esters), lignin sulfonates, alkyl benzene sulfonates, fatty acid cyanamides, anionic sulfosuccinic acid surfactants, fatty acid isethionates, acylaminoalkane sulfonates (fatty acid taurides), fatty acid sarcosinates, ether carboxylic acids and alkyl (ether) phosphates may, however, additionally be used.

Further anionic surfactants which are likewise suitable are gemini surfactants with a diphenyl oxide basic structure, 2 sulfonate groups and an alkyl residue on one or both benzene rings of the formula “O₃S(C₆H₃R)O(CO₆H₃R′)SO₃⁻¹ in which R denotes an alkyl residue having for example 6, 10, 12 or 16 carbon atoms and R′ denotes R or H (Dowfax® Dry Hydrotrope Powder with C₁₋₆ alkyl residue(s); INCI Sodium Hexyldiphenyl Ether Sulfonate, Disodium Decyl Phenyl Ether Disulfonate, Disodium Lauryl Phenyl Ether Disulfonate, Disodium Cetyl Phenyl Ether Disulfonate) and fluorinated anionic surfactants, in particular perfluorinated alkyl sulfonates such as ammonium C_{9/10}-perfluoroalkylsulfonate (Fluorad® FC 120) and perfluorooctanesulfonic acid potassium salt (Fluorad® FC 95).

### Amphoteric Surfactants

Amphoteric surfactants (amphosurfactants, zwitterionic surfactants) which may be used according to the invention include betaines, alkylamidoalkylamines, alkyl-substituted amino acids, acylated amino acids or biosurfactants, with betaines being preferred for the purposes of the teaching according to the invention. Suitable betaines are alkylbetaines, the alkylamidobetaines, imidazoliniumbetaines, sulfobetaines (INCI Sultaines) and phosphobetaines; alkylamidobetaines, for example cocoamidopropylbetaine, are particularly preferred here.

### Nonionic Surfactants

The agent according to the invention may additionally contain one or more nonionic surfactants, conventionally in a quantity of 0.001 to 5 wt. %, preferably of 0.01 to 4 wt. %, in particular of 0.1 to 3 wt. %, particularly preferably of 0.2 to 2 wt. %, extremely preferably of 0.5 to 1.5 wt. %, for example 1 wt. %.

Nonionic surfactants for the purposes of the invention are alkoxylates such as polyglycol ethers, fatty alcohol polyglycol ethers, alkylphenol polyglycol ethers, end group-terminated polyglycol ethers, mixed ethers and hydroxy mixed ethers and fatty acid polyglycol esters. Block polymers prepared from ethylene oxide and propylene oxide together with fatty acid alkanolamides and fatty acid polyglycol ethers are likewise suitable. Further important classes of nonionic surfactants according to the invention are amine oxides and sugar surfactants, in particular alkyl polyglucosides.

### Further Ingredients

### Water-Soluble Salts

The cleaning agent according to the invention may furthermore contain one or more water-soluble salts which serve, for example to establish viscosity. These may comprise inorganic and/or organic salts; in a preferred embodiment the agent contains at least one inorganic salt.

Inorganic salts which may be used according to the invention are preferably selected from the group comprising colourless water-soluble halides, sulfates, sulfites, carbonates, hydrogencarbonates, nitrates, nitrites, phosphates and/or oxides of alkali metals, alkaline earth metals, of aluminium and/or the transition metals; ammonium salts may furthermore be used. Halides and sulfates of alkali metals are particularly preferred; the inorganic salt is therefore preferably selected from the group comprising sodium chloride, potassium chloride, sodium sulfate, potassium sulfate and mixtures thereof.

The organic salts usable according to the invention in particular comprise colourless water-soluble alkali metal, alkaline earth metal, ammonium, aluminium and/or transition metal salts of carboxylic acids. The salts are preferably selected from the group comprising formate, acetate, propionate, citrate, malate, tartrate, succinate, malonate, oxalate, lactate and mixtures thereof.

### Solvents

The water content of the aqueous agent according to the invention conventionally amounts to 15 to 90 wt. %, preferably 20 to 85 wt. %, in particular 30 to 80 wt. %.

The agent according to the invention may advantageously additionally contain one or more water-soluble organic solvents, conventionally in a quantity of 0.1 to 30 wt. %, preferably of 1 to 20 wt. %, in particular of 2 to 15 wt. %, particularly preferably of 3 to 12 wt. %, extremely preferably of 4 to 8 wt. %.

For the purposes of the teaching according to the invention, the solvent is in particular used as a hydrotropic agent, viscosity regulator and/or low-temperature stabiliser. It has a solubilising action in particular for surfactants and electrolyte and for perfume and colorant and so assists in the incorporation thereof, prevents the formation of liquid crystalline phases and has a part in the formation of clear products. The viscosity of the agent according to the invention falls as the quantity of solvent increases Too much solvent may, however, bring about an excessive reduction in viscosity. Finally, the low temperature cloud point and clear point of the agent according to the invention falls as the amounts of solvent increases.

Preferred solvents are C₂₋₆ alkylene glycols, optionally etherified on one side with a C₁₋₆ alkanol, and poly-C₂₋₃-alkylene glycol ethers having on average 1 to 9 identical or different, preferably identical, alkylene glycol groups per molecule, as well as C₁₋₆ alcohols. The solvent is preferably selected from the group comprising methanol, ethanol, propanol, isopropanol, ethylene glycol, propylene glycol and mixtures thereof.

Extremely preferred solvents are the C₂₋₃ alcohols ethanol, n-propanol and/or iso-propanol, in particular ethanol.

Solubilising agents other than the above-described solvents which may in particular be used for perfume and colorants are, for example, also alkanolamines and alkyl benzene sulfonates having 1 to 3 carbon atoms in the alkyl residue.

### Further Ingredients

In addition to the previously stated components, the agents according to the invention may contain further ingredients. These include, for example, further surfactants, additives for improving draining and drying behaviour, for establishing viscosity, for stabilisation together with further auxiliary substances and additives conventional in manual dishwashing detergents, for instance UV stabilising agents, perfume, pearlescent agents, colorants, corrosion inhibitors, preservatives, organic salts, disinfectants, enzymes and pH adjusting agents.

### Cationic Surfactants

The agent according to the invention may additionally contain one or more cationic surfactants (INCI Quaternary Ammonium Compounds), conventionally in a quantity of 0.001 to 5 wt. %, preferably of 0.01 to 4 wt. %, in particular of 0.1 to 3 wt. %, particularly preferably of 0.2 to 2 wt. %, extremely preferably of 0.5 to 1.5 wt. %, for example 1 wt. %.

Preferred cationic surfactants are quaternary surface-active compounds, in particular having an ammonium, sulfonium, phosphonium, iodonium or arsonium group. By using quaternary surface-active compounds having an antimicrobial action, it is possible to provide the agent with an antimicrobial action or to improve any antimicrobial action which it may already have due to other ingredients.

Particularly preferred cationic surfactants are the quaternary ammonium compounds (QAC; INCI Quaternary Ammonium Compounds) of the general formula (R^{I})(R^{II})(R^{III})(R^{IV})N⁺X⁻, in which R^{I} to R^{IV} represent identical or different C₁₋₂₂ alkyl residues, C₇₋₂₈ aralkyl residues or heterocyclic residues, wherein two or, in the case of aromatic incorporation as in pyridine, even three residues form the heterocycle together with the nitrogen atom, for example a pyridinium or imidazolinium compound, and X⁻ are halide ions, sulfate ions, hydroxide ions or similar anions. To ensure optimum antimicrobial action, at least one of the residues preferably has a chain length of 8 to 18, in particular of 12 to 16, C atoms.

In order to avoid possible incompatibilities of the cationic surfactants with the anionic surfactants present according to the invention, the cationic surfactants used are those which are as highly compatible with anionic surfactants and/or are as slightly cationic as possible or, in one particular embodiment of the invention, cationic surfactants are completely omitted.

### Viscosity

The favourable viscosity for the agent according to the invention at 20° C. and a shear rate of 30 min⁻¹, measured with a Brookfield LV DV II model viscosimeter and spindle 31, is below 5,000 mPa·s, preferably below 2,000 mPa·s, in particular below 1,000 mPa·s, particularly preferably below 500 mPa·s, extremely preferably below 250 mPa·s, for example 40 to 100 mPa·s.

The viscosity of the agent according to the invention may, in particular when the agent has a low surfactant content, be increased by thickeners and/or, in particular when the agent has an elevated surfactant content, be reduced by water-soluble inorganic salts present therein and by solvents.

### Thickeners

The agent according to the invention may additionally contain one or more polymeric thickeners for thickening.

Polymeric thickeners for the purposes of the present invention are polycarboxylates which, as polyelectrolytes, have a thickening action, preferably homo- and copolymers of acrylic acid, in particular acrylic acid copolymers such as acrylic acid/methacrylic acid copolymers, and polysaccharides, in particular heteropolysaccharides, and other conventional thickening polymers. Suitable polysaccharides or heteropolysaccharides are polysaccharide gums, for example gum arabic, agar, alginates, carrageenan and the salts thereof, guar, guaran, tragacanth, gellan, ramsan, dextran or xanthan and the derivatives thereof, for example propoxylated guar, and the mixtures thereof. Other polysaccharide thickeners, such as starches or cellulose derivatives, may however alternatively preferably be used in addition to a polysaccharide gum, for example starches of the most varied origin and starch derivatives, for example hydroxyethyl starch, starch phosphate esters or starch acetates, or carboxymethylcellulose or the sodium salt thereof, methyl-, ethyl-, hydroxyethyl-, hydroxypropyl-, hydroxypropylmethyl- or hydroxyethylmethylcellulose or cellulose acetate.

One preferred polymeric thickener is the microbial anionic heteropolysaccharide xanthan gum, which is produced by Xanthomonas campestris and some other species under aerobic conditions with a molecular weight of 2-15×10⁶ and is obtainable, for example, from Kelco under the trade name Keltrol®, for example as a cream coloured powder Keltrol® T (Transparent) or as a white granular product Keltrol® RD (Readily Dispersible).

Acrylic acid polymers suitable as polymeric thickeners are, for example, high molecular weight homopolymers of acrylic acid crosslinked with a polyalkenyl polyether, in particular an allyl ether of sucrose, pentaerythritol or propylene (INCI Carbomer), which are also known as carboxyvinyl polymers. Such polyacrylic acids are obtainable inter alia from B.F. Goodrich under the trade name Carbopol®, for example Carbopol® 940 (molecular weight approx. 4,000,000), Carbopol® 941 (molecular weight approx. 1,250,000) or Carbopol® 934 (molecular weight approx. 3,000,000).

The content of polymeric thickeners conventionally amounts to no more than 8 wt. %, preferably between 0.1 and 7 wt. %, particularly preferably between 0.5 and 6 wt. %, in particular between 1 and 5 wt. % and extremely preferably between 1.5 and 4 wt. %, for example between 2 and 2.5 wt. %.

In a preferred embodiment of the invention, however, the agent contains no polymeric thickeners.

### Dicarboxylic Acid (Salts)

In order to stabilise the agent according to the invention, in particular in the case of an elevated surfactant content, one or more dicarboxylic acids and/or the salts thereof may be added, in particular a composition of the sodium salts of adipic, succinic and glutaric acid, as is for example obtainable under the trade name Sokalan® DSC. Addition is here advantageously in quantities of 0.1 to 8 wt. %, preferably of 0.5 to 7 wt. %, in particular of 1.3 to 6 wt. % and particularly preferably of 2 to 4 wt. %.

Modifying the dicarboxylic acid (salt) content may, in particular in quantities of above 2 wt. %, assist in providing a clear solution of the ingredients. It is likewise possible within certain limits to influence the viscosity of the mixture by this agent. This component furthermore has an influence on the solubility of the mixture. This component is particularly preferably used at elevated surfactant contents, in particular at surfactant contents above 30 wt. %.

Use thereof may, however, be dispensed with, in which case the agent according to the invention preferably contains no dicarboxylic acid(s)/dicarboxylic acid salt(s).

### Auxiliary Substances and Additives

In addition one or more further conventional auxiliary substances and additives, in particular in manual dishwashing detergents and cleaning agents for hard surfaces, may also be present, in particular UV stabilising agents, perfume, pearlescent agents (INCI Opacifying Agents; for example glycol distearate, for example Cutina® AGS from Cognis, or mixtures containing this, for example Euperlane® from Cognis), colorants, corrosion inhibitors, preservatives (for example technical 2-bromo-2-nitropropane-1,3-diol (CAS 52-51-7) which is also known as bronopol and is commercially obtainable for example as Myacide® BT or as Boots Bronopol BT from Boots), organic salts, disinfectants, enzymes and pH adjusting agents, in quantities of conventionally no more than 5 wt. %.

### pH Value

The pH value of the agent according to the invention may be established by means of conventional pH regulators, for example acids such as mineral acids or citric acid and/or alkalis such as sodium or potassium hydroxide, wherein, in particular where hand compatibility is desired, a range from 4 to 9, preferably 5 to 8, in particular 5.5 to 7.5, is preferred.

In order to establish and/or stabilise the pH value, the agent according to the invention may contain one or more buffer substances (INCI Buffering Agents), conventionally in quantities of 0.001 to 5 wt. %, preferably of 0.005 to 3 wt. %, in particular of 0.01 to 2 wt. %, particularly preferably of 0.05 to 1 wt. %, extremely preferably of 0.1 to 0.5 wt. %, for example of 0.2 wt. %. Preferred buffer substances are those which are simultaneously complexing agents or even chelating agents (chelators, INCI Chelating Agents). Particularly preferred buffer substances are citric acid or citrates, in particular sodium and potassium citrates, for example trisodium citrate.2H₂O and tripotassium citrate.H₂O.

Examples of Foamable, Flowable Dishwashing Detergents

| | Formulation 1 | Formulation 2 | Formulation 3 |
|---|---|---|---|
| | (in wt. %) | (in wt. %) | (in wt. %) |
| Anionic surfactant | 49 | 49 | 53.57 |
| (Hostapur SAS 60) | | | |
| Amphoteric | 14.78 | 14.78 | 10.87 |
| surfactant | | | |
| (Tego betaine C60) | | | |
| Socalan DCS | 23.33 | 0 | 0 |
| NaCl | 0 | 3 | 3 |
| PPG 400 | 0 | 0 | 5 |
| Lupranol 1200 | 0 | 3 | 0 |
| Ethanol | 11 | 8 | 8 |
| H₂O | 1.88 | 22.22 | 19.56 |
| Viscosity (mPa·s) | 62 | 82 | 55 |

Example of a Foamable, Cosmetic Product

Anionic surfactants (E1) which are suitable in preparations according to the invention are any anionic surface-active substances suitable for use on the human body. These are characterised by an anionic water-solubilising group such as for example a carboxylate, sulfate, sulfonate or phosphate group and a lipophilic alkyl group having some 8 to 30 C atoms. The molecule may additionally contain glycol or polyglycol ether groups, ester, ether and amide groups and hydroxyl groups. Examples of suitable anionic surfactants are, in each case in the form of sodium, potassium and ammonium and the mono-, di- and trialkanolammonium salts having 2 to 4 C atoms in the alkanol group,
linear and branched fatty acids with 8 to 30 C atoms (soaps),
ether carboxylic acids of the formula R—O—(CH₂—CH₂O)x-CH₂—COOH, in which R is a linear alkyl group having 8 to 30 C atoms and x=0 or 1 to 16,
acyl sarcosides having 8 to 24 C atoms in the acyl group,
acyl taurides having 8 to 24 C atoms in the acyl group,
acyl isethionates having 8 to 24 C atoms in the acyl group,
sulfosuccinic acid mono- and dialkyl esters having 8 to 24 C atoms in the alkyl group and sulfosuccinic acid monoalkyl polyoxyethyl esters having 8 to 24 C atoms in the alkyl group and 1 to 6 oxyethyl groups,
linear alkane sulfonates having 8 to 24 C atoms,
linear alpha-olefin sulfonates having 8 to 24 C atoms,
alpha-sulfofatty acid methyl esters of fatty acids having 8 to 30 C atoms,
alkyl sulfates and alkyl polyglycol ether sulfates of the formula R—O(CH₂—CH₂O)x-OSO₃H, in which R is a preferably linear alkyl group having 8 to 30 C atoms and x=0 or 1 to 12,
mixtures of surface-active hydroxysulfonates according to DE-A-37 25 030,
sulfated hydroxyalkyl polyethylene and/or hydroxyalkylene propylene glycol ethers according to DE-A-37 23 354,
sulfonates of unsaturated fatty acids having 8 to 24 C atoms and 1 to 6 double bonds according to DE-A-39 26 344,
esters of tartaric acid and citric acid with alcohols, which are addition products of approx. 2-15 molecules of ethylene oxide and/or propylene oxide onto fatty alcohols having 8 to 22 C atoms,
alkyl- and/or alkenyl ether phosphates of the formula (E1-I),

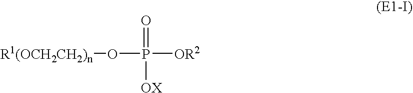

in which R¹ preferably denotes an aliphatic hydrocarbon residue with 8 to 30 carbon atoms, R² denotes hydrogen, a residue (CH₂CH₂O)ₙR¹ or X, n denotes numbers from 1 to 10 and X denotes hydrogen, an alkali or alkaline earth metal or NR³R⁴R⁵R⁶, with R³ to R⁶ mutually independently denoting hydrogen or a C₁ to C₄ hydrocarbon residue, sulfated fatty acid alkylene glycol esters of the formula (E1-II)

R⁷CO(AlkO)ₙSO₃M (E1-II)
in which R⁷CO— denotes a linear or branched, aliphatic, saturated and/or unsaturated acyl residue with 6 to 22 C atoms, Alk denotes CH₂CH₂, CHCH₃CH₂ and/or CH₂CHCH₃, n denotes numbers from 0.5 to 5 and M denotes a cation, as they are described in DE-OS 197 36 906.5,
monoglyceride sulfates and monoglyceride ether sulfates of the formula (E1-III)

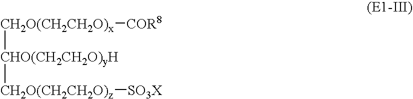

in which R⁸CO denotes a linear or branched acyl residue having 6 to 22 carbon atoms, x, y and z in total denote 0 or denote numbers from 1 to 30, preferably 2 to 10, and X denotes an alkali or alkaline earth metal. Typical examples of monoglyceride (ether) sulfates suitable for the purposes of the invention are the reaction products of lauric acid monoglyceride, coconut fatty acid monoglyceride, palmitic acid monoglyceride, stearic acid monoglyceride, oleic acid monoglyceride and tallow fatty acid monoglyceride and the ethylene oxide addition products thereof with sulfur trioxide or chlorosulfonic acid in the form of the sodium salts thereof. Monoglyceride sulfates of the formula (E1-III) which are preferably used are those in which R⁸CO denotes a linear acyl residue having 8 to 18 carbon atoms, as have for example been described in EP-B1 0 561 825, EP-B1 0 561 999, DE-A1 42 04 700 or by A. K. Biswas et al. in J. Am. Oil Chem. Soc. 37, 171 (1960) and F. U. Ahmed in J. Am. Oil Chem. Soc. 67, 8 (1990),
amidoether carboxylic acids as are described in EP 0 690 044,
condensation products prepared from C₈-C₃₀ fatty alcohols with protein hydrolysates and/or amino acids and the derivatives thereof, which are known to a person skilled in the art as protein/fatty acid condensation products, such as for example Lamepon® grades, Gluadin® grades, Hostapon® KCG or Amisoft® grades.

Preferred anionic surfactants are alkyl sulfates, alkyl polyglycol ether sulfates and ether carboxylic acids having 10 to 18 C atoms in the alkyl group and up to 12 glycol ether groups per molecule, sulfosuccinic acid mono- and dialkyl esters having 8 to 18 C atoms in the alkyl group and sulfosuccinic acid monoalkyl polyoxyethyl esters having 8 to 18 C atoms in the alkyl group and 1 to 6 oxyethyl groups, monoglyceryl disulfates, alkyl and alkenyl ether phosphates and protein/fatty acid condensation products.

Those surface-active compounds which bear at least one quaternary ammonium group and at least one —COO⁽⁻⁾ or —SO₃⁽⁻⁾ group on each molecule are designated as zwitterionic surfactants (E2). Particularly suitable zwitterionic surfactants are “betaines” such as N-alkyl N,N-dimethylammonium glycinates, for example cocoalkyldimethylammonium glycinate, N-acylaminopropyl-N,N-dimethylammonium glycinates, for example cocoacylaminopropyldimethylammonium glycinate, and 2-alkyl-3-carboxymethyl-3-hydroxyethylimidazolines having in each case 8 to 18 C atoms in the alkyl or acyl group and cocoacylaminoethylhydroxyethylcarboxymethyl glycinate. One preferred zwitterionic surfactant is the fatty acid amide derivative known by the INCI name Cocamidopropyl Betaine.

Ampholytic surfactants (E3) are taken to mean those surface-active compounds which, in addition to a C₈-C₂₄ alkyl or acyl group, contain at least one free amino group and at least one —COOH or —SO₃H group per molecule and are capable of forming internal salts. Examples of suitable ampholytic surfactants are N-alkylglycines, N-alkylpropionic acids, N-alkylaminobutyric acids, N-alkyliminodipropionic acids, N-hydroxyethyl-N-alkylamidopropyl-glycines, N-alkyltaurines, N-alkylsarcosines, 2-alkylaminopropionic acids and alkylaminoacetic acids having in each case approx. 8 to 24 C atoms in the alkyl group. Particularly preferred ampholytic surfactants are N-cocoalkyl amino-propionate, cocoacylaminoethyl aminopropionate and C₁₂₋₁₈-acyl sarcosine.

Nonionic surfactants (E4) contain as hydrophilic group for example a polyol group, a polyalkylene glycol ether group or a combination of a polyol group and polyglycol ether group. Such compounds are for example
addition products of 2 to 50 mol of ethylene oxide and/or 0 to 5 mol of propylene oxide onto linear and branched fatty alcohols having 8 to 30 C atoms, onto fatty acids having 8 to 30 C atoms and onto alkylphenols having 8 to 15 C atoms in the alkyl group,
addition products, end group-terminated with a methyl or C₂-C₆ alkyl residue, of 2 to 50 mol of ethylene oxide and/or 0 to 5 mol of propylene oxide onto linear and branched fatty alcohols having 8 to 30 C atoms, onto fatty acids having 8 to 30 C atoms and onto alkylphenols having 8 to 15 C atoms in the alkyl group, such as for example the grades obtainable under the commercial names Dehydrol® LS, Dehydrol® LT (Cognis),
C₁₂-C₃₀ fatty acid mono- and diesters of addition products of 1 to 30 mol of ethylene oxide onto glycerol,
addition products of 5 to 60 mol of ethylene oxide onto castor oil and hardened castor oil,
polyol fatty acid esters, such as for example the commercial product Hydagen® HSP (Cognis) or Sovermol grades (Cognis),
alkoxylated triglycerides,
alkoxylated fatty acid alkyl esters of the formula (E4-I)

R¹CO—(OCH₂CHR²)_{w}OR³ (E4-I)
in which R¹CO denotes a linear or branched, saturated and/or unsaturated acyl residue having 6 to 22 carbon atoms, R² denotes hydrogen or methyl, R³ denotes linear or branched alkyl residues having 1 to 4 carbon atoms and w denotes numbers from 1 to 20,
amine oxides,
hydroxy mixed ethers, as are for example described in DE-OS 19738866,
sorbitan fatty acid esters and addition products of ethylene oxide onto sorbitan fatty acid esters such as for example polysorbates,
sugar fatty acid esters and addition products of ethylene oxide onto sugar fatty acid esters,
addition products of ethylene oxide onto fatty acid alkanolamides and fatty amines,
sugar surfactants of the alkyl and alkenyl oligoglycoside type of the formula (E4-II),

R⁴O-[G]ₚ (E4-II)
in which R⁴ denotes an alkyl or alkenyl residue having 4 to 22 carbon atoms, G denotes a sugar residue having 5 or 6 carbon atoms and p denotes numbers from 1 to 10. They may be obtained in accordance with the relevant methods of preparative organic chemistry. Reference is made, representatively of the comprehensive literature, to the review article by Biermann et al. in Starch/Stärke 45, 281 (1993), B. Salka in Cosm. Toil. 108, 89 (1993) and J. Kahre et al. in SÖFW-Journal, issue 8, 598 (1995). Alkyl and alkenyl oligoglycosides may be derived from aldoses or ketoses having 5 or 6 carbon atoms, preferably from glucose. Preferred alkyl and/or alkenyl oligoglycosides are thus alkyl and/or alkenyl oligoglucosides. The index value p in the general formula (E4-II) indicates the degree of oligomerisation (DP), i.e. the distribution of mono- and oligoglycosides, and denotes a number between 1 and 10. While p must always be integral in the individual molecule and in this case may primarily assume the values p=1 to 6, the value p for a specific alkyl oligoglycoside is a calculated value determined by analysis and is usually a fractional number. Alkyl and/or alkenyl oligoglycosides having an average degree of oligomerisation p of 1.1 to 3.0 are preferably used. From an applicational standpoint, preferred alkyl and/or alkenyl oligoglycosides are those whose degree of oligomerisation is less than 1.7 and in particular is between 1.2 and 1.4. The alkyl or alkenyl residue R⁴ may be derived from primary alcohols having 4 to 11, preferably 8 to 10 carbon atoms. Typical examples are butanol, caproic alcohol, caprylic alcohol, capric alcohol and undecyl alcohol and the technical mixtures thereof, as are, for example, obtained from the hydrogenation of technical fatty acid methyl esters or in the course of hydrogenation of aldehydes from Roelen's oxo synthesis. Preferred alkyl oligoglucosides are those of a C₈-C₁₀ chain length (DP=1 to 3) which occur as forerunnings in the distillative separation of technical C₈-C₁₈ coconut fatty alcohol and may be contaminated with a proportion of less than 6 wt. % of C₁₂ alcohol and alkyl oligoglucosides based on technical C_{9/11} oxo alcohols (DP=1 to 3). The alkyl or alkenyl residue R¹⁵ may furthermore also be derived from primary alcohols having 12 to 22, preferably 12 to 14 carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and the technical mixtures thereof, which may be obtained as described above. Preferred alkyl oligoglucosides are those based on hardened C_{12/14} coconut alcohol with a DP of 1 to 3.
sugar surfactants of the fatty acid N-alkyl polyhydroxyalkylamide type, a nonionic surfactant of the formula (E4-III),

R⁵CO—NR⁶-[Z] (E4-III)
in which R⁵CO denotes an aliphatic acyl residue having 6 to 22 carbon atoms, R⁶ denotes hydrogen, an alkyl or hydroxyalkyl residue having 1 to 4 carbon atoms and [Z] denotes a linear or branched polyhydroxyalkyl residue having 3 to 12 carbon atoms and 3 to 10 hydroxyl groups. The fatty acid N-alkylpolyhydroxyalkylamides comprise known substances which may conventionally be obtained by reductive amination of a reducing sugar with ammonia, an alkylamine or an alkanolamine and subsequent acylation with a fatty acid, a fatty acid alkyl ester or a fatty acid chloride. Reference is made to U.S. Pat. No. 1,985,424, U.S. Pat. No. 2,016,962 and U.S. Pat. No. 2,703,798 and to international patent application WO 92106984 with regard to methods for the production thereof. A review of this topic by H. Kelkenberg may be found in Tens. Surf. Det. 25, 8 (1988). The fatty acid N-alkylpolyhydroxyalkylamides are preferably derived from reducing sugars having 5 or 6 carbon atoms, in particular from glucose. The preferred fatty acid N-alkylpolyhydroxyalkylamides are therefore fatty acid N-alkylglucamides, as represented by the formula (E4-IV):

R⁷CO—NR⁸—CH₂—(CH—OH)₄—CH₂OH (E4-IV)
Fatty acid N-alkylpolyhydroxyalkylamides which are preferably used are glucamides of the formula (E4-IV), in which R⁸ denotes hydrogen or an alkyl group and R⁷CO denotes the acyl residue of caproic acid, caprylic acid, capric acid, lauric acid, myristic acid, palmitic acid, palmoleic acid, stearic acid, isostearic acid, oleic acid, elaidic acid, petroselinic acid, linoleic acid, linolenic acid, arachidic acid, gadoleic acid, behenic acid or erucic acid or the technical mixtures thereof. Particularly preferred fatty acid N-alkylglucamides of the formula (E4-IV) are those which are obtained by reductive amination of glucose with methylamine and subsequent acylation with lauric acid or C12/14 coconut fatty acid or a corresponding derivative. The polyhydroxyalkylamides may also be derived from maltose and palatinose.

Preferred nonionic surfactants have proved to be alkylene oxide addition products onto saturated linear fatty alcohols and fatty acids with in each case 2 to 30 mol of ethylene oxide per mol of fatty alcohol or fatty acid respectively. Preparations having excellent properties are likewise obtained if they contain fatty acid esters of ethoxylated glycerol as the nonionic surfactants.

These compounds are characterised by the following parameters. The alkyl residue R contains 6 to 22 carbon atoms and may be both linear and branched. Primary linear aliphatic residues and those methyl-branched in position 2 are preferred. Such alkyl residues are for example 1-octyl, 1-decyl, 1-lauryl, 1-myristyl, 1-cetyl and 1-stearyl. 1-Octyl, 1-decyl, 1-lauryl, 1-myristyl are particularly preferred. When “oxo alcohols” are used as starting materials, compounds having an uneven number of carbon atoms in the alkyl chain predominate.

Sugar surfactants are furthermore very particularly preferred nonionic surfactants. These may preferably be present in the agents used according to the invention in quantities of 0.1-20 wt. %, relative to the entire agent. Quantities from 0.5-15 wt. % are preferred, while quantities of 0.5-7.5 wt. % are very particularly preferred.

The compounds with alkyl groups used as surfactant may in each case comprise uniform substances. It is, however, generally preferred to start from native plant or animal raw materials when producing these substances, such that mixtures of substances having a differing alkyl chain length depending on the particular raw material are obtained.

The surfactants which are addition products of ethylene and/or propylene oxide onto fatty alcohols or derivatives of these addition products may be used both as products with a “normal” homologue distribution and as products with a narrow homologue distribution. A “normal” homologue distribution is here taken to mean mixtures of homologues which are obtained on reacting fatty alcohol and alkylene oxide using alkali metals, alkali metal hydroxides or alkali metal alkoxides as catalysts. Narrow homologue distributions, in contrast, are obtained if hydrotalcite, alkaline earth metal salts of ether carboxylic acids, alkaline earth metal oxides, hydroxides or alkoxides are for example used as catalysts. It may be preferred to use products with a narrow homologue distribution.

The surfactants (E) are used in quantities of 0.1-45 wt. %, preferably of 0.5-30 wt. % and very particularly preferably of 0.5-25 wt. %, relative to the entire agent used according to the invention.

Cationic surfactants (E5) may likewise be used according to the invention. Typical examples of cationic surfactants are in particular tetraalkylammonium compounds, amidoamines or alternatively ester quats. Preferred quaternary ammonium compounds are ammonium halides, in particular chlorides and bromides, such as alkyltrimethylammonium chlorides, dialkyldimethylammonium chlorides and trialkylmethylammonium chlorides, for example cetyltrimethylammonium chloride, stearyltrimethylammonium chloride, distearyldimethylammonium chloride, lauryldimethylammonium chloride, lauryidimethylbenzylammonium chloride, tricetylmethylammonium chloride, Hydroxyethyl Hydroxycetyl Dimonium Chloride and the imidazolium compounds known by the INCI names Quaternium-27 and Quaternium-83. The long alkyl chains of the above-stated surfactants preferably comprise 10 to 28 carbon atoms. The alkyl chains of the above-stated surfactants preferably have a chain length of 14 to 28 carbon atoms, particularly preferably of 14 to 22 carbon atoms and very particularly preferably of 16 to 22 carbon atoms.

Ester quats are known substances which contain both at least one ester function and at least one quaternary ammonium group as a structural element.

These comprise, for example, quaternised fatty acid triethanolamine ester salts of the formula (E5-I),

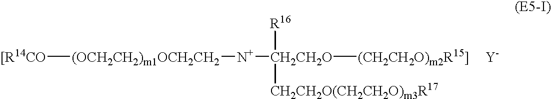

in which R¹⁴CO denotes an acyl residue having 6 to 22 carbon atoms, R¹⁵ and R¹⁶ mutually independently denote hydrogen or R¹⁴CO, R¹⁵ denotes an alkyl residue having 1 to 4 carbon atoms or a (CH₂CH₂O)ₘ₄H-group, m1, m2 and m3 in total denote 0 or numbers from 1 to 12, m4 denotes numbers from 1 to 12 and Y denotes halide, alkyl sulfate or alkyl phosphate. Typical examples of ester quats which may be used for the purposes of the invention are products based on caproic acid, caprylic acid, capric acid, lauric acid, myristic acid, palmitic acid, isostearic acid, stearic acid, oleic acid, elaidic acid, arachidic acid, behenic acid and erucic acid and the technical mixtures thereof, as are for example obtained from the pressure splitting of natural fats and oils, Technical C_{12/18} coconut fatty acids and in particular partially hardened C_{16/18} tallow or palm fatty acids and C_{16/18} fatty acid cuts having a high elaidic acid content are preferably used. The quaternised esters may be produced by introducing the fatty acids and the triethanolamine in a molar ratio of 1.1:1 to 3:1. A ratio of 1.2:1 to 2.2:1, preferably of 1.5:1 to 1.9:1 has proven particularly advantageous with regard to the applicational properties of the ester quats. Preferred ester quats are technical mixtures of mono-, di- and triesters with an average degree of esterification of 1.5 to 1.9 which are derived from technical C_{16/18} tallow or palm fatty acid (iodine value 0 to 40). From an applicational standpoint, particularly advantageous quaternised fatty acid triethanolamine ester salts of the formula (E5-I) have proved to be those in which R¹⁴CO denotes an acyl residue having 16 to 18 carbon atoms, R¹⁵ denotes R¹⁵CO, R¹⁶ denotes hydrogen, R¹⁷ denotes a methyl group, m1, m2 and m3 denote 0 and Y denotes methyl sulfate.

In addition to the quaternised fatty acid triethanolamine ester salts, further ester quats which may be considered are also quaternised ester salts of fatty acids with diethanolalkylamines of the formula (E5-II),

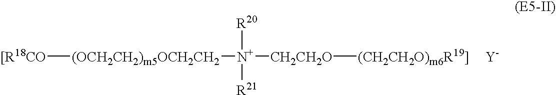

in which R¹⁸CO denotes an acyl residue having 6 to 22 carbon atoms, R¹⁹ denotes hydrogen or R¹⁸CO, R²⁰ and R²¹ mutually independently denote alkyl residues having 1 to 4 carbon atoms, m5 and m6 in total denote 0 or numbers from 1 to 12 and Y again denotes halide, alkyl sulfate or alkyl phosphate.

Another group of suitable ester quats which may finally be mentioned are the quaternised ester salts of fatty acids with 1,2-dihydroxypropyldialkylamines of the formula (E5-III),

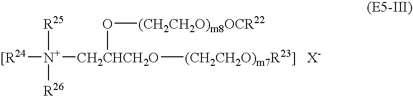

in which R²²CO denotes an acyl residue with 6 to 22 carbon atoms, R²³ denotes hydrogen or R²²CO, R²⁴, R²⁵ and R²⁶ mutually independently denote alkyl residues having 1 to 4 carbon atoms, m7 and m8 in total denote 0 or numbers from 1 to 12 and X again denotes halide, alkyl sulfate or alkyl phosphate.

Substances which may finally also be considered as ester quats are those in which the ester is replaced by an amide bond and, preferably based on diethylenetriamine, comply with the formula (E5-IV),

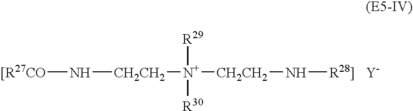

in which R²⁷CO denotes an acyl residue with 6 to 22 carbon atoms, R²⁸ denotes hydrogen or R²⁷CO, R²⁹ and R³⁰ mutually independently denote alkyl residues having 1 to 4 carbon atoms and Y again denotes halide, alkyl sulfate or alkyl phosphate. Such amide ester quats are, for example, commercially obtainable under the trademark Incroquat® (Croda).

Preferred ester quats are quaternised ester salts of fatty acids with triethanolamine, quaternised ester salts of fatty acids with diethanolalkylamines and quaternised ester salts of fatty acids with 1,2-dihydroxypropyldialkylamines. Such products are sold, for example, under the trademarks Stepantex®, Dehyquart® and Armocare®. The products Armocare® VGH-70, an N,N-bis(2-palmitoyloxyethyl)dimethylammonium chloride, and Dehyquart® F-75, Dehyquart® C-4046, Dehyquart® L80 and Dehyquart® AU-35 are examples of such ester quats.

The alkylamidoamines are conventionally produced by amidating natural or synthetic fatty acids and fatty acid cuts with dialkylaminoamines. One compound from this group of substances which is particularly suitable according to the invention is stearamidopropyldimethylamine which is commercially available under the name Tegoamid® S 18.

The teaching according to the invention also includes the recognition that more than one cationic surfactant may be used in the agents according to the invention. In this case, it may be preferred for the cationic surfactants to be selected from at least two different groups. When mixtures of cationic surfactants are used, it may furthermore be advantageous not to select from just two different groups of cationic surfactants, but additionally also to select greatly different or virtually identical C chain lengths of the cationic surfactants. Accordingly, cetyltrimethylammonium chloride is for example advantageously blended according to the invention with Dehyquart® L-80. Another advantageous mixture of two cationic surfactants is for example the combination of behentrimonium chloride with dicetyldimethylammonium chloride. The mixing ratio when at least two cationic surfactants are used amounts to 10:1-1:10, preferably 7:1-1:7, particularly preferably 5:1-1:5, very particularly preferably 3:1-1:3 and very highly preferably 1.5:1-1:1.5.

The agents used according to the invention preferably contain the cationic surfactants (E5) in quantities of 0.05 to 10 wt. %, relative to the entire agent. Quantities of 0.1 to 5 wt. % are particularly preferred.

Anionic, nonionic, zwitterionic and/or amphoteric surfactants and mixtures thereof may be preferred according to the invention.

Emulsifiers (F) are used in another preferred embodiment. Emulsifiers bring about the formation of water- or oil-resistant adsorption layers at the phase interface, which protect the dispersed droplets from coalescence and so stabilise the emulsion. Emulsifiers, like surfactants, are thus made up of a hydrophobic and a hydrophilic molecular moiety. Hydrophilic emulsifiers preferably form O/W emulsions while hydrophobic emulsifiers preferably form W/O emulsions. An emulsion is taken to mean a droplet distribution (dispersion) of one liquid in another liquid with the input of energy to create stabilising phase interfaces by means of surfactants. The selection of these emulsifying surfactants or emulsifiers is here determined on the basis of the substances to be dispersed and the particular external phase and the fineness of the emulsion. Further definitions and properties of emulsifiers may be found in “H.-D. Dörfler, Grenzflächen-und Kolloidchemie [interfacial and colloid chemistry], VCH Verlagsgesellschaft mbH, Weinheim, 1994”. Examples of emulsifiers which may be used according to the invention are:
addition products of 4 to 30 mol of ethylene oxide and/or 0 to 5 mol of propylene oxide onto linear fatty alcohols having 8 to 22 C atoms, onto fatty acids having 12 to 22 C atoms and onto alkylphenols having 8 to 15 C atoms in the alkyl group,
C₁₂-C₂₂ fatty acid mono- and diesters of addition products of 1 to 30 mol of ethylene oxide onto polyols having 3 to 6 carbon atoms, in particular onto glycerol,
ethylene oxide and polyglycerol addition products onto methyl glucoside/fatty acid esters, fatty acid alkanolamides and fatty acid glucamides,
C₈-C₂₂ alkyl mono- and oligoglycosides and the ethoxylated analogues thereof, with degrees of oligomerisation of 1.1 to 5, in particular of 1.2 to 2.0, and glucose as the sugar component being preferred,
mixtures of alkyl (oligo)glucosides and fatty alcohols, for example the commercially available product Montanov®68,
addition products of 5 to 60 mol of ethylene oxide onto castor oil and hardened castor oil,
partial esters of polyols having 3-6 carbon atoms with saturated fatty acids having 8 to 22 C atoms,
sterols. Sterols are taken to be a group of steroids which bear a hydroxyl group on C atom 3 of the steroid skeleton and may be isolated both from animal tissue (zoosterols) and from vegetable fats (phytosterols). Examples of zoosterols are cholesterol and lanosterol. Examples of suitable phytosterols are ergosterol, stigmasterol and sitosterol. Sterols are also isolated from fungi and yeasts, these being known as mycosterols.
phospholipids. These are primarily taken to mean glucose phospholipids which are for example obtained as lecithins, or phosphatidylcholines for example from egg yolk or plant seeds (for example soya beans).
fatty acid esters of sugars and sugar alcohols, such as sorbitol,
polyglycerols and polyglycerol derivatives such as for example polyglycerol poly-12-hydroxystearate (commercial product Dehymuls® PGPH),
linear and branched fatty acids having 8 to 30 C atoms and the Na, K, ammonium, Ca, Mg and Zn salts thereof.

The agents according to the invention preferably contain the emulsifiers in quantities of 0.1-25 wt. %, in particular of 0.5-15 wt. %, relative to the entire agent.

The compositions according to the invention may preferably contain at least one nonionogenic emulsifier with an HLB value of 8 to 18 in accordance with the definitions provided in Römpp-Lexikon Chemie (eds. J. Falbe, M. Regitz), 10th edition, Georg Thieme Verlag Stuttgart, New York, (1997), page 1764. Nonionogenic emulsifiers with an HLB value of 10-15 may be particularly preferred according to the invention.

Nothing in this specification should be considered as limiting the scope of the present invention. The above described embodiments of the invention are non-limiting and may be modified or varied, and elements added or omitted, without departing from the invention, as appreciated by persons skilled in the art in light of the above teachings. It is therefore to be understood that the invention is to be measured by the scope of the claims, and may be practiced in alternative manners to those which have been specifically described in the specification.

### REFERENCE NUMERALS

1 container
2 flowable product
3 airspace
4 outer container wall
5 outer container wall
6 upper container wall
7 bottom container wall
8 mixing chamber
9 communication element
10 product feed element
11 air feed element
12 pressure equalising valve
13 partition
14 porous element
15 dispensing orifice
16 mixing chamber partition
17 plate element
18 container foot
19 communication element
20 product feed element
21 air feed element
22 flowable product
23 airspace
24 porous element
25 dispensing orifice
26 communication orifice
27 air inlet orifices
28 mixing chamber
29 applicator foot
30 foam outlet orifice
31 closing element
32 pressure equalising valve
33 pressure equalising valve
34 inner container wall
35 inner container wall
36 inner upper container wall
37 inner bottom container wall
38 airspace

What is claimed is:

1. A container for at least one flowable product, comprising:
at least one chamber within the container for holding the at least one flowable product,
at least one airspace within the container,
at least one wall of said container with at least one section that is at least partially deformable so that when said wall is in a deformed state, pressure increases within the airspace,
at least one mixing chamber, and
at least one communication element that connects the mixing chamber with the airspace,
wherein, upon an increase in pressure in the airspace, air and the flowable product in said chamber, which flowable product at room temperature has a viscosity of less than 250 mPa·s and has a proportion of foaming agents of greater than 10 wt. %, may be brought together in the mixing chamber in substantially turbulent manner.

2. The container according to claim 1, wherein air and flowable product are brought together in the mixing chamber at Reynolds numbers of greater than 1,200.

3. The container according to claim 1, further comprising:
a product feed element for feeding the flowable product into the mixing chamber and controlling flowable product inflow; and
an air feed element that controls inflow of air from the airspace to the mixing chamber.

4. The container according to claim 3, wherein the air feed element is constructed such that, in the event of an increase in pressure in the airspace, said air feed element permits the inlet of air from the airspace into the mixing chamber before the product feed element permits the inlet of flowable product into the mixing chamber.

5. The container according to claim 3, wherein the product feed element is constructed such that, in the event of a pressure drop in the airspace, said product feed element stops the inlet of flowable product into the mixing chamber before the air feed element shuts off the inlet of air from the airspace into the mixing chamber.

6. The container according to claim 3, wherein the product feed element and/or air feed element take the form of valves.

7. The container according to claim 1, wherein the mixing chamber is at least partially filled with one or more porous elements.

8. The container according to claim 1, further comprising: a pressure equalising valve associated with the container, which pressure equalizing valve is designed such that, when a reduced pressure prevails in the airspace, air can flow from the surroundings into the airspace.

9. The container according to claim 1, wherein the container has at least one deformable walls that following deformation substantially automatically returns to its original undeformed shape.

10. The container according to claim 1, wherein the container comprises a plurality of chambers separated from one another for accommodating two or more products.

11. The container according to claim 10, wherein the two or more products may be brought together in the mixing chamber.

12. The container according to claim 10, wherein the two or more products may be introduced individually and separately into the mixing chamber and a second mixing chamber that is separate from the mixing chamber.

13. The container according to claim 10, further comprising at least one inner chamber that is arranged inside the at least one chamber.

14. The container according to claim 13, wherein the mixing chamber of the inner chamber is connected with the mixing chamber of the at least one chamber.

15. The container according to claim 13, wherein the inner chamber is a pouch filled with flowable product.

16. The container according to claim 1, further comprising:
means which convert the flow of the flowable product or of air in the mixing chamber into a rotation of one or more dispensing orifices about a longitudinal axis of a foam applicator forming an exit from the mixing chamber.

17. The container according to claim 1, wherein, in an undeformed state of the container, a gas or gas mixture is located in the at least one airspace which is under a higher pressure than ambient pressure outside the container.
